(19) United States
(12) Patent Application Publication
(10) Pub. No.: US 2012/0145336 A1
(43) Pub. Date: Jun. 14, 2012

(54) BLIND STRUCTURE CHARACTERIZED BY ENHANCED USER SAFETY

(75) Inventor: Ju-Huai Chen, Changhua County (TW)

(73) Assignee: CHICOLOGY, INC., Ontario, CA (US)

(21) Appl. No.: 12/966,779

(22) Filed: Dec. 13, 2010

(51) Int. Cl. E06B 9/24

(52) U.S. Cl. 160/188

(57) ABSTRACT

A blind structure characterized by enhanced user safety includes a blind holder, an elevating unit coupled to the blind holder, and a second shade. The blind holder includes an upper beam and a first shade coupled thereto. The elevating unit includes a batten, a transmitting member disposed at one end of the batten, and a tractional member for driving the transmitting member. The batten is movably coupled to the upper beam. The second shade has one end connected to the first shade and the other end connected to the batten. The blind structure advantageously works on the principles of: moving a second shape vertically with an elevating unit, moving a first shade vertically with the second shade, thereby dispensing with tractional cords and lifting cords and precluding the human body from being entangled with the tractional cords and lifting cords otherwise required, so as to enhance user safety.

### FIELD OF THE INVENTION

The present invention relates to blind structures characterized by enhanced user safety, and more particularly, to a blind structure capable of dispensing with tractional cords and lifting cords, effective in preventing the human body from becoming entangled with tractional cords and lifting cords, and thus advantageously characterized by enhanced user safety.

### BACKGROUND OF THE INVENTION

A conventional blind (such as a Roman blind) comprises an upper beam, an elevating unit, and a shade coupled to the bottom of the upper beam. The elevating unit has a plurality of tractional cords and lifting cords. The shade comprises a plurality of slats. At least a plurality of holes are formed in each of the slats. The holes are lined up and penetrated by the lifting cords in a manner that the lifting cords are fixed to the lowest ones of the holes, respectively. To lift or lower the shade, a user pulls the tractional cords to thereby lift or lower the shade with the lifting cords.

The conventional blind has a drawback. The tractional cords are always found on one side of the shade. Toddlers are likely to put the tractional cords on their necks out of curiosity or during an inadvertent act committed in play. With a tractional cord on the neck, a toddler may end up in strangulation. Hence, tractional cords of the conventional blind pose a serious threat to child safety.

Accordingly, it is imperative to develop a blind structure that enhances user safety and dispenses with tractional cords and lifting cords which might otherwise be a cause of strangulation.

### SUMMARY OF THE INVENTION

In view of the shortcomings of the conventional blind structures, the inventor of the present invention understands the prior art has room for improvement, conducted extensive researches and experiments according to the inventor's years of experience in the related industry, and finally developed a blind structure characterized by enhanced user safety as disclosed in the present invention to achieve the goal of enhancement of user safety.

It is a primary objective of the present invention to provide a blind structure characterized by enhanced user safety and effective in lifting or lowering a second shade by an elevating unit, lifting or lowering a first shade by the second shade, and dispensing with a tractional cord and a lifting cord to thereby prevent strangulation which might otherwise happen whenever the human body entangles itself in the tractional cord or the lifting cord.

In order to achieve the above and other objectives, the present invention provides a blind structure characterized by enhanced user safety, including: a blind holder comprising an upper beam and a first shade having an end coupled to the upper beam; an elevating unit coupled to the blind holder, wherein the elevating unit comprises a batten movably coupled to the upper beam, a transmitting member disposed at an end of the batten, and a tractional member for driving the transmitting member; and a second shade having an end connected to the first shade and another end connected to the batten.

In an embodiment of the present invention, end holders are disposed at two ends of the upper beam, respectively, and movably coupled to an elevating unit.

In an embodiment of the present invention, a plurality of clamping members are disposed on the first shade and configured to effectuate positional limitation in conjunction with the second shade.

In an embodiment of the present invention, the clamping members each comprise: a transverse rod disposed on the first shade; a limiting element corresponding in position to a surface of the second shade; and engaging elements disposed at two ends of the limiting element, respectively, and engaged with the transverse rod.

In an embodiment of the present invention, the tractional member is provided thereon with paired connecting elements capable of interactive movable connection.

In an embodiment of the present invention, the second shade is made from a non-woven fabric.

Accordingly, the present invention provides a blind structure characterized by enhanced user safety and effective in lifting or lowering a second shade by an elevating unit, lifting or lowering a first shade by the second shade, and dispensing with a tractional cord and a lifting cord to thereby prevent strangulation which might otherwise happen whenever the human body entangles itself in the tractional cord or the lifting cord.

### BRIEF DESCRIPTION OF THE DRAWINGS

A detailed description of further features and advantages of the present invention is given below so that a person skilled in the art can understand and implement the technical contents of the present invention and readily comprehend the objectives, features, and advantages thereof by reviewing the disclosure of the present specification and the appended claims in conjunction with the accompanying drawings, in which:

FIG. 1 is a perspective view of a blind structure of the present invention;

FIG. 2 is an exploded view of the blind structure of the present invention; and

FIG. 3 is a schematic view of the blind structure in use according to the present invention.

### DETAILED DESCRIPTION OF THE PREFERRED EMBODIMENTS

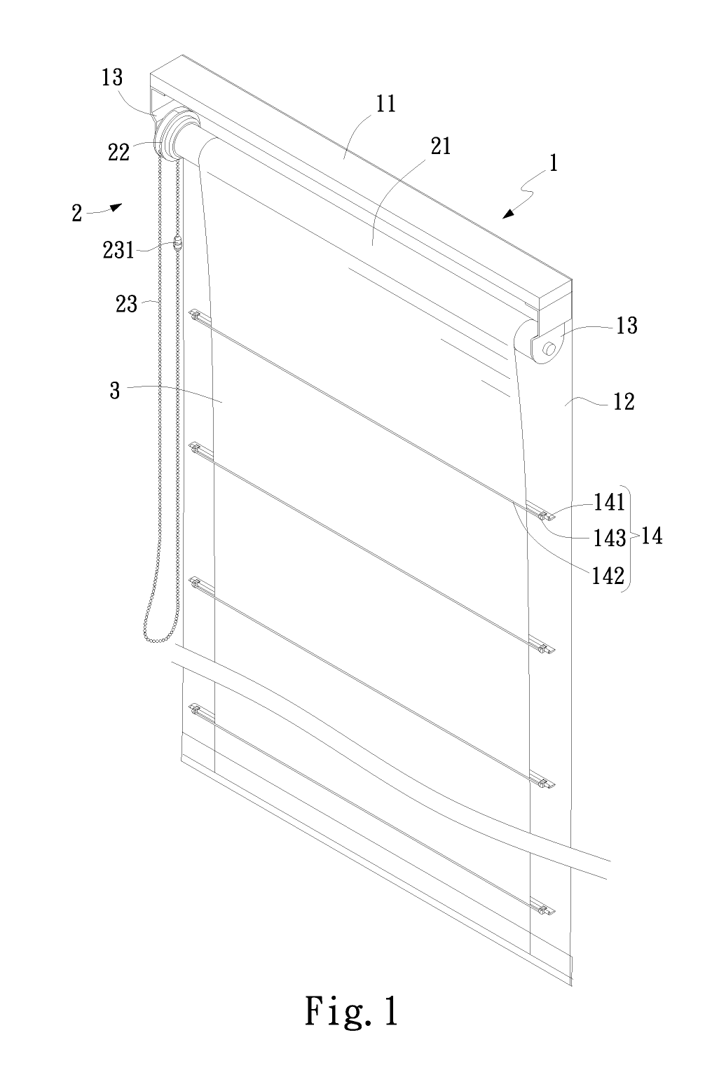

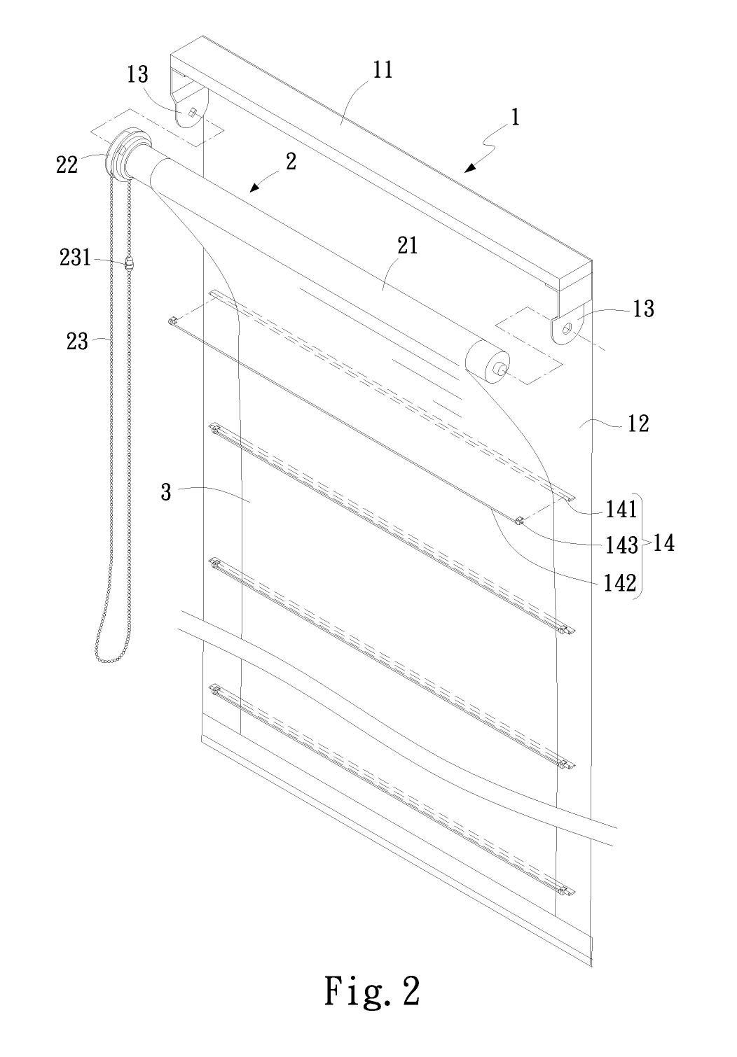

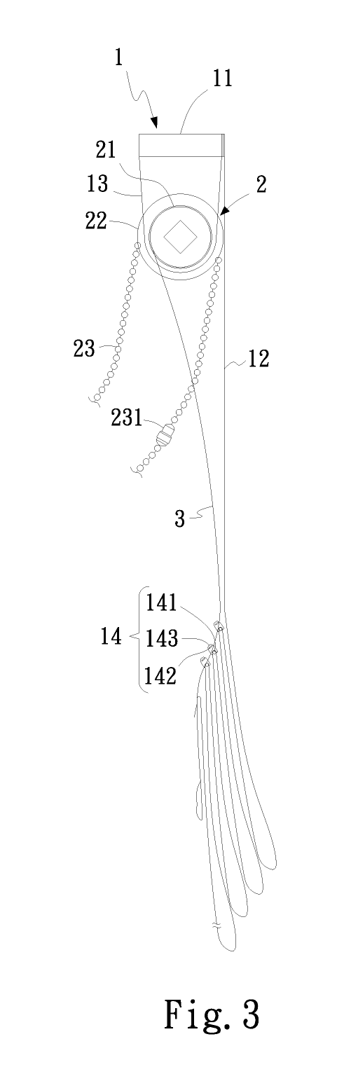

Referring to FIG. 1, FIG. 2, and FIG. 3, there are shown a perspective view, an exploded view, and a usage-related schematic view of a blind structure of the present invention, respectively. As shown in the drawings, the present invention provides a blind structure characterized by enhanced user safety, comprising a blind holder 1, an elevating unit 2, and a second shade 3.

The blind holder 1 comprises an upper beam 11 and a first shade 12 with one end coupled to the upper beam 11. End holders 13 are disposed at two ends of the upper beam 11, respectively. A plurality of clamping members 14 are disposed on the first shade 12 and configured to effectuate positional limitation in conjunction with the second shade 3. The clamping members 14 each comprise: a transverse rod 141 disposed on the first shade 12; a limiting element 142 corresponding in position to a surface of the second shade 3; and engaging elements 143 disposed at two ends of the limiting element 142, respectively, and engaged with the transverse rod 141.

The elevating unit 2 is coupled to the blind holder 1. The elevating unit 2 comprises a batten 21, a transmitting member 22, and a tractional member 23. The batten 21 is movably coupled to the end holders 13 disposed at the two ends of the upper beam 11. The transmitting member 22 is disposed at one end of the batten 21. The tractional member 23 is configured to drive the transmitting member 22 and is provided thereon with paired connecting elements 231 capable of interactive movable connection.

The second shade 3 has one end connected to the first shade 12 and the other end connected to the batten 21. The second shade 3 is made from a non-woven fabric.

To install the blind structure of the present invention, a user attaches the upper beam 11 of the blind holder 1 to the top end of a window frame (not shown). To lift the blind structure of the present invention, the user gives a pull at a lifting-oriented portion of the tractional member 23 to enable the tractional member 23 to drive the transmitting member 22 to rotate the batten 21 such that the second shade 3 is wound onto the batten 21 by the rotation thereof; meanwhile, the second shade 3 drives the first shade 12 to lift, so as to effectuate a blind-lifting movement. After the first shade 12 has lifted and come to a preset position, it is no longer necessary to exert any force upon the lowering-oriented portion of the tractional member 23, because it is the time to enable the batten 21 to stop taking in the second shade 3 and allow the first shade 12 to be positioned at a preset position.

Conversely, to lower the first shade 12, the user has to give a pull at a lowering-oriented portion of the tractional member 23 such that the transmitting member 22 drives the batten 21 to rotate reversely; as a result, the second shade 3 lowers, and thus the first shade 12 lowers too.

Even if a toddler puts the tractional member 23 around its body, such as the neck, out of curiosity or during an inadvertent act committed in play, the tractional member 23 will be subjected to a pull (stronger than is required to move the first shade 12 and the second shade 3), such that the paired connecting elements 231 of the tractional member 23 will separate, thereby preventing the tractional member 23 from being wound around the human body and thus promoting user safety. If the toddler gives a relatively strong pull at the first shade 12 or the second shade 3, the engaging elements 143 at two ends of the limiting element 142 of the clamping members 14 will be disengaged from the transverse rod 141, thereby enhancing user safety. Upon termination of the aforesaid emergency, the user may couple together the transverse rod 141 and the engaging elements 143 at two ends of the limiting element 142, such that the blind structure of the present invention is available for use again.

Hence, the present invention meets the three requirements of patentability, namely novelty, non-obviousness, and industrial applicability. Regarding novelty and non-obviousness, the present invention discloses moving a second shape upward or downward by means of an elevating unit, moving a first shade upward or downward by means of the second shade, thereby dispensing with tractional cords and lifting cords and precluding the human body from being entangled with the tractional cords and lifting cords otherwise disclosed in the prior art, so as to enhance user safety. Regarding industrial applicability, products derived from the present invention meet market demands fully.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and replacements made to the foregoing embodiments should fall within the scope of the present invention as set forth in the appended claims. Accordingly, the protection for the present invention should be defined by the appended claims.

What is claimed is:

1. A blind structure characterized by enhanced user safety, comprising:
a blind holder comprising an upper beam and a first shade having an end coupled to the upper beam;
an elevating unit coupled to the blind holder, wherein the elevating unit comprises a batten movably coupled to the upper beam, a transmitting member disposed at an end of the batten, and a tractional member for driving the transmitting member; and
a second shade having an end connected to the first shade and another end connected to the batten.

2. The blind structure of claim 1, wherein end holders are disposed at two ends of the upper beam, respectively, and movably coupled to the elevating unit.

3. The blind structure of claim 1, wherein a plurality of clamping members are disposed on the first shade and configured to effectuate positional limitation in conjunction with the second shade.

4. The blind structure of claim 3, wherein the clamping members each comprise: a transverse rod disposed on the first shade; a limiting element corresponding in position to a surface of the second shade; and engaging elements disposed at two ends of the limiting element, respectively, and engaged with the transverse rod.

5. The blind structure of claim 1, wherein the tractional member is provided thereon with paired connecting elements capable of interactive movable connection.

6. The blind structure of claim 1, wherein the second shade is made from a fabric.
